(19) United States
(12) Patent Application Publication
(10) Pub. No.: US 2005/0037312 A1
(43) Pub. Date: Feb. 17, 2005

(54) Orthodontic retainer

(75) Inventor: Shinya Uchida, Yokohama-shi (JP)

Correspondence Address: OLIFF & BERRIDGE, PLC, P.O. BOX 19928, ALEXANDRIA, VA, 22320, US

(73) Assignees: ASO INTERNATIONAL, INC, Tokyo (JP); SHINYA UCHIDA, Yokohama-shi (JP)

(21) Appl. No.: 10/871,012

(22) Filed: Jun. 21, 2004

(30) Foreign Application Priority Data
Jun. 20, 2003 (JP) 2003-176353

(51) Int. Cl. A61C 3/00

(52) U.S. Cl. 433/6; 433/18

(57) ABSTRACT

The present invention relates to an orthodontic retainer to be fitted to an orthodontically treated dentition in order to fix the teeth in their orthodontic treatment state. In particular, the present invention relates to an orthodontic retainer that achieves, for example, improvement of strength of the retainer, improvement of wearing comfort and esthetics, reduction in cost, and improvement of a function as the retainer.

### BACKGROUND OF THE INVENTION

1. Field of the Invention

The present invention relates to an orthodontic retainer to be fitted to an orthodontically treated dentition in order to fix the teeth in their orthodontic treatment state.

2. Description of the Related Art

An example of a conventional orthodontic retainer is shown in FIG. 46. As shown in the figure, the retainer 1 includes a wire 23, which is disposed in a labial arch in contact with the outside surfaces of teeth, and a synthetic resin section 31, which includes unevenness fitting with the inside surfaces of the teeth. The orthodontic retainer 1 is fitted to the teeth by inserting the teeth in a gap defined between the wire 23 and the unevenness of the synthetic resin section 31. In such an orthodontic retainer, the synthetic resin section 31 located inside the teeth is required to have a moderate flexibility. On the other hand, since such a synthetic resin section 31 having flexibility is provided so as to impart a retaining force to the teeth (the “retaining force” means a force for retaining the teeth in their orthodontic treatment state), the synthetic resin section 31 of the retainer 1 inevitably has a large size and is formed thick and wide. In particular, as shown in FIG. 46, the synthetic resin section 31 in the maxillary retainer 1 covers almost an entire maxilla (hard palate) in the oral cavity. Since the retainer 1 includes such a large synthetic resin section, drawbacks as described below occur in the retainer 1.
(1) Wearing comfort is bad with odd feeling;
(2) Disturbance of pronunciation is caused;
(3) It is hard to eat foods at meals, and the sense of tasting foods and drinks is spoiled;
(4) Since the synthetic resin section has low thermal conductivity, a wearer cannot sense temperature of foods and drinks sensitively;
(5) Since the synthetic resin section is susceptible to odors and soils, the wearer feels discomfort; and
(6) The synthetic resin section is easily broken when it is larger in size.

Since it is necessary to use an orthodontic retainer over a very long period of time, these problems are serious for a user of the orthodontic retainer.

Thus, JP-A-8-168500 and U.S. Pat. No. 5,536,169 propose a solution to such problems.

In FIGS. 47 to 52, reference sign 21a denotes a maxillary retainer, and 21b denotes a mandibular retainer. In the maxillary retainer 21a, both ends 25a of a wire section 23a, which is in contact with outside surfaces 5a of maxillary teeth 3a, are coupled to a substantially U-shaped metal support 27a located inside the maxillary teeth 3a, and a synthetic resin section 31a, which includes unevenness 29a fitting with inside surfaces 7a of the maxillary teeth 3a, is fixed to the metal support 27a such that the maxillary teeth 3a are inserted in a gap 33a defined between the wire section 23a and the unevenness 29a of the synthetic resin section 31a.

On the other hand, in the mandibular retainer 21b, both ends 25b of a wire section 23b, which is in contact with outside surfaces 5b of the mandible teeth 3b, are coupled to a substantially U-shaped metal support 27b located inside the mandible teeth 3b, and a synthetic resin section 31b, which includes unevenness 29b fitting with inside surfaces 7b of the mandible teeth 3b, is fixed to the metal support 27b such that the maxillary teeth 3b may be inserted in a gap 33b defined between the wire section 23b and the unevenness 29b of the synthetic resin section 31b.

The wire sections 23a and 23b are formed of, for example, a cobalt chromium alloy. The metal supports 27a and 27b are formed of, for example, of a titanium alloy, a cobalt chromium alloy, or a PGA (platinum alloy). The synthetic resin sections 31a and 31b are formed of a material having an adequate flexibility such as polycarbonate or acrylic resins.

First metal reinforcing members 35 having one ends 35′ thereof fixed to the metal support 27a are embedded in the synthetic resin section 31a in the maxillary retainer 21a.

In addition, second metal reinforcing members 37 with one ends 37′ thereof fixed to the metal support 27b are passed through the synthetic resin section 31b in the mandibular retainer 21b to project the other ends 37″ of the second metal reinforcing members 37 from the synthetic resin section 31b.

Third metal reinforcing members 39 with one ends 39′ thereof fixed to the metal support 27a are passed through the synthetic resin section 31a in the maxillary retainer 21a to fix the other ends 39″, which are projected from the synthetic resin section 31a in the third metal reinforcing members 39, to the wire section 23a.

In the orthodontic retainer with such a structure, the thickness and width of both the synthetic resin section and the substantially U-shaped metal support can be reduced remarkably. Therefore, even when the orthodontic retainer is fitted to the maxillary teeth or mandibular teeth, the maxilla or mandible in the oral cavity is not entirely covered by the orthodontic retainer. Thus, it is said that the orthodontic retainer shows the following advantages:
(1) Wearing comfort is good without odd feeling;
(2) Disturbance of pronunciation is not caused;
(3) It is easy to eat foods at meals, and the sense of tasting foods and drinks is not spoiled;
(4) Since the synthetic resin section having low thermal conductivity is extremely reduced in thickness and width, a wearer can sense temperature of foods and drinks sensitively;
(5) Since the synthetic resin section susceptible to odors and soils is extremely reduced in thickness and width, the orthodontic retainer is clean;
(6) Since the supports are made of metal, the orthodontic retainer is strong;
(7) Since the synthetic resin section is minimized, it is not likely that the retainer is cracked;
(8) The other end of the second metal reinforcing member 37 is engaged with the upper surfaces of the teeth, whereby the orthodontic retainer can be fixed to the teeth more surely; and
(9) The orthodontic retainer can be fixed to the teeth more surely by the third metal reinforcing member 39.

However, the conventional orthodontic retainer has several difficulties as described below:
(1) Although JP-A-8-168500 referred to above mentions that “both the synthetic resin section and the substantially U-shaped metal support can be extremely reduced in thickness and width,” the metal support thereof is made of an expensive titanium alloy, cobalt chromium alloy, PGA (platinum alloy), or the like. The retainer is fixed (supported) such that an opposite surface of the synthetic resin section including unevenness fitting the inside surface of the teeth is connected to one end face of a flat forging thereof (see FIGS. 47, 48, and 50).

A reinforcing effect for the synthetic resin section (the metal support as well) cannot be expected much from such simple adhesion with the synthetic resin section backed up by the metal support. Although it is stated that the synthetic resin section is reinforced by embedding the first metal reinforcing member 35, which is fixed to the metal support 27a, in and across the synthetic resin section, such a reinforcing relation cannot be found anywhere in the patent application.

Besides, a material cost is high, and the reduction in an amount of synthetic resin is not significant because the reinforcement is insufficient.
(2) Since the retainer has a simple plate-like arcuate loop frame, it is very difficult to permanently bear twists repeatedly applied in lateral, longitudinal, and vertical directions. Nevertheless, no means for counteracting such vulnerability is provided.
(3) Since the mutual reinforcement effect between the synthetic resin and the metal support is small, the synthetic resin section cannot be reduced greatly in size, and thus odd feeling of a wearer in wearing the retainer cannot be eliminated enough.
(4) Since the metal support directly touches the palate, tongue, or foods, it is necessary to use flat forging of titanium alloy, cobalt chromium alloy or PGA (platinum alloy), and the material cost increases inevitably.
(5) The wire section is exposed over the entire outside surfaces of the teeth, which causes a problem from an aesthetic viewpoint. In addition, the wearer is adversely affected mentally.
(6) The conventional orthodontic retainer does not have any effectuate function of effectively distributing and relieving the pressure of the perioral muscle such as the orbicular muscle of the mouth and the buccinator muscle acting from the outside surfaces of the dental arch, which is one of main factors of a relapse of the teeth after orthodontic treatment. Therefore, pressure is applied to the dentition of anterior teeth or posterior teeth, and there occurs a problem of inducing the relapse.

### SUMMARY OF THE INVENTION

The present invention has been devised in view of the above-mentioned circumstances, and it is an object of the present invention to provide an orthodontic retainer using inexpensive standardized materials, in which both a synthetic resin section and a metal support act to effectively reinforce each other so as to reduce an amount of the synthetic resin to be used, and which has sufficient strength and elasticity to bear repeated twists.

It is another object of the present invention to provide an orthodontic retainer that has a function of effectively relieving pressure of the perioral muscle such as the orbicular muscle of the mouth and the buccinator muscle acting from the outside surfaces of the dental arch so as to prevent a relapse of the teeth after orthodontic treatment.

It is yet another object of the present invention to provide an orthodontic retainer that is so excellent aesthetically with minimized exposure of a metal support that a patient does not refrain from wearing the same worrying about the public eye.

It is still another object of the present invention to provide an inexpensive orthodontic retainer that is easily fitted to the dentition and is simple but hygienic with reduced wearing discomfort.

In order to achieve the above objects, an orthodontic retainer of the present invention is constituted as described below.

The present invention provides a maxillary retainer including a resin plate retained to a palatal periphery that has clasps at both ends thereof, is embedded with a substantially U-shaped reinforcing wire extending along the inside of the dental arch and a bridge wire coupling both the clasps and traversing a posterior edge of a palate thereof, includes unevenness fitting with inside surfaces of the teeth, and is formed in a shape with most portions thereof hollowed out leaving a part of 4 to 5 mm from a contour periphery thereof where the reinforcing wire and the bridge wire are embedded. In the maxillary retainer, the reinforcing wire extending from the clasps and the bridge wire are brazed to each other, and the periphery of the resin plate has a thickness minimized to a height of a crown bulge region at a prosterior teeth region in the same manner as the conventional retainer at posterior teeth.

A labial arch wire in contact with the outside surfaces of the teeth is provided between both the clasps.

Resin is added to the labial arch wire at the anterior teeth.

The resin plate is provided with an incision in a median portion of the resin plate traversing the anterior teeth and the palate, and an omega loop is added to the wires exposed from the incision.

The reinforcing wire disposed adjacent and along the cervix on the palatal surface is added with an auxiliary spring wire after cutting the resin.

A lip pad consisting of a resin pad is retained at a position opposed to the outside surface of the cervix with a gap formed between them.

Inside surfaces of the anterior teeth are directly bonded with a coupling wire, and the resin plate has unevenness fitting with the inside surfaces of the teeth.

The resin plate and the reinforcing wire on the inside surface of the anterior teeth, where the coupling wire is bonded, are removed.

A pair of ball clasps, which are brazed to the reinforcing wire and nip both side ends of the anterior teeth, are added.

The ball clasps is replaced with hook clasps, and a synthetic resin chain, which connects the hook clasps and is in abutment against the surfaces of the anterior teeth, is added.

The present invention also provides a mandibular retainer including a resin plate that has clasps at both ends thereof, includes a labial arch wire extending along outside surfaces of the dental arch and unevenness fitting with inside surfaces of the teeth, and is hollowed out leaving a portion 4-5 mm from a contour periphery thereof where a substantially U-shaped reinforcing wire extending along the inside of the dental arch is embedded. In the mandibular retainer, the reinforcing wire and the labial arch wire are brazed to each other, the periphery of the resin plate has a thickness thereof minimized to a height of the cervix at anterior teeth on and piled the same as conventional retainer at posterior teeth, resin on the lingual surface of the anterior teeth is divided, and an enlarged wire is added along a lower portion of the resin plate.

Further, the present invention provides a mandibular retainer including a resin plate that has clasps at both ends thereof, includes unevenness fitting with inside surfaces of the teeth, and is hollowed out leaving a portion 4-5 mm from a contour periphery thereof where a substantially U-shaped reinforcing wire extending along the inside of the dental arch is embedded. In the mandibular retainer, a labial arch wire in contact with the outside surfaces of the teeth is provided between both the clasps, the periphery of the resin plate has a thickness thereof minimized to a height of the cervix at anterior teeth and to piled the same as conventional retainer at posterior teeth, and the resin plate is provided with an incision in a median portion at anterior teeth thereof such that an omega loop is added to the wires exposed from the incision.

A lip pad including a resin pad is provided such that the resin pad of the shock absorber is retained at a position opposed to an outside surface of the cervix with a gap formed between them.

Inside surfaces of the anterior teeth are directly bonded with a coupling wire, the unevenness fitting with the inside surfaces of the teeth are fitted with the inside surfaces of the anterior teeth, where the coupling wire is directly bonded, at the resin periphery.

The resin plate and the reinforcing wire on the inside surface of the anterior teeth, where the coupling wire is bonded, are removed.

A pair of ball clasps, which are brazed to the reinforcing wire and nip both side ends of the anterior teeth, are added.

The ball clasps are replaced with hook clasps, and a synthetic resin chain, which connects the hook clasps and is in abutment against the surfaces of the anterior teeth, is added.

Bent metal wires are joined to a main wire, which is disposed along the cervical area on a lingual side of the dental arch, to fit the cervix of the respective teeth such that the teeth are retained.

The posterior is provided with a molded resin portions along a shape of the cervix of the posterior teeth.

The clasps are formed as C clasps surrounding a first molars.

The clasps are formed as Adams clasps surrounding the first molars.

The clasps are formed as bifurcated C clasps surrounding first and rearmost molars.

### BRIEF DESCRIPTION OF THE DRAWINGS

In the accompanying drawings:

FIG. 1 is a view showing a maxillary retainer according to an embodiment of the present invention;

FIG. 2 is a view showing another embodiment of the maxillary retainer;

FIG. 3 is a view showing a wire provided on the labial surface of the dental arch;

FIG. 4 is a view showing C clasps of the wire provided on the labial surface of the dental arch;

FIG. 5 is a view showing another embodiment of the maxillary retainer;

FIG. 6 is a view showing yet another embodiment of the maxillary retainer;

FIG. 7 is a view showing yet another embodiment of the maxillary retainer;

FIG. 8 is a view showing resin provided on the labial surface of the dental arch;

FIG. 9 is a view showing yet another embodiment of the maxillary retainer;

FIG. 10 is a view showing yet another embodiment of the maxillary retainer;

FIG. 11 is a view showing yet another embodiment of the maxillary retainer;

FIG. 12 is a view showing yet another embodiment of the maxillary retainer;

FIG. 13 is a view showing an embodiment of a mandibular retainer according to the present invention;

FIG. 14 is a view showing another embodiment of the mandibular retainer;

FIG. 15 is a view showing yet another embodiment of the mandibular retainer;

FIG. 16 is a sectional view along line A-A of the retainer shown in FIG. 2;

FIG. 17 is a sectional view along line B-B of the retainer shown in FIG. 2;

FIG. 18 is a view showing yet another embodiment of the maxillary retainer;

FIG. 19 is a view showing a resin pad for a lip pad;

FIG. 20 is a view showing the resin pad for the lip pad;

FIG. 21 is a view showing yet another embodiment of the mandibular retainer;

FIG. 22 is a view showing yet another embodiment of the maxillary retainer;

FIG. 23 is a view showing the resin pad for the buccal shield;

FIG. 24 is a view showing the resin pad for the buccal shield;

FIG. 25 is a view showing yet another embodiment of the mandibular retainer;

FIG. 26 is a view showing yet another embodiment of the maxillary retainer;

FIG. 27 is a view showing yet another embodiment of the maxillary retainer;

FIG. 28 is a view showing yet another embodiment of the maxillary retainer;

FIG. 29 is a view showing yet another embodiment of the maxillary retainer;

FIG. 30 is a view showing yet another embodiment of the mandibular retainer;

FIG. 31 is a view showing yet another embodiment of the mandibular retainer;

FIG. 32 is a view showing a wire bonded to a lingual side of anterior teeth;

FIG. 33 is a view showing yet another embodiment of the maxillary retainer;

FIG. 34 is a view showing yet another embodiment of the mandibular retainer;

FIG. 35 is a view showing yet another embodiment of the maxillary retainer and the mandibular retainer;

FIG. 36 is a view showing yet another embodiment of the maxillary retainer and the mandibular retainer;

FIG. 37 is a view showing yet another embodiment of the maxillary retainer and the mandibular retainer;

FIG. 38 is a view showing yet another embodiment of the maxillary retainer and the mandibular retainer;

FIG. 39 is a view showing ball clasps;

FIG. 40 is a view showing hook clasps;

FIG. 41 is a view showing yet another embodiment of the maxillary retainer;

FIG. 42 is a view showing yet another embodiment of the maxillary retainer;

FIG. 43 is a view showing yet another embodiment of the maxillary retainer;

FIG. 44 a partially enlarged view showing yet another embodiment of the maxillary retainer;

FIG. 45 is a view showing yet another embodiment of the maxillary retainer;

FIG. 46 is an explanatory view showing a conventional orthodontic retainer;

FIG. 47 is an explanatory view showing the conventional orthodontic retainer;

FIG. 48 is an explanatory view showing a state of use of the conventional orthodontic retainer;

FIG. 49 is an explanatory view showing the conventional orthodontic retainer;

FIG. 50 is an explanatory view showing the conventional orthodontic retainer;

FIG. 51 is an explanatory view showing the conventional orthodontic retainer; and

FIG. 52 is an explanatory view showing the conventional orthodontic retainer.

### DESCRIPTION OF THE PREFERRED EMBODIMENTS

An embodiment of a retainer in accordance with the present invention will be explained with reference to the accompanying drawings.

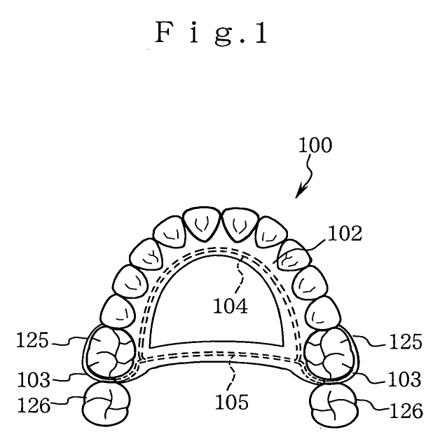

FIG. 1 shows the maxillary retainer 100 according to the embodiment of the present invention. The maxillary retainer 100 has a frame-like resin plate 102 that includes unevenness fitting with inside surfaces of teeth and one side traversing a posterior edge of a palate thereof and has a shape with a central portion thereof hollowed out leaving a part of 4-5 mm from a contour periphery thereof. A reinforcing wire 104 is embedded in the resin plate 102 along the inside surfaces of the teeth, and a bridge wire 105 is embedded therein along the side traversing the posterior edge of the palate. Both ends of the bridge wire 105 are brazed to both ends of the reinforcing wire 104. Further, a C clasp 103 is brazed to each of the ends of the reinforcing wire 104.

The maxillary retainer 100 is attached on the teeth with the C clasps 103 hooked to first molars 125. Note that the teeth to which the C clasps 103 are hooked are not limited to the first molars 125 but may be rearmost molars such as second molars 126.

In this way, according to the retainer 100, the reinforcing wire 104 and the bridge wire 105 are embedded in the resin, whereby a mutual reinforcement effect of the resin plate 102 and the wires is exhibited sufficiently. Thus, the retainer 100 itself has a function of controlling a relapse to the inside of the dental arch.

The resin bar provided across posterior edge of the palate (bridge between both the clasps) yields a cubic structure, which prevents subsidence or torsion of the retainer 100 and a relapse in a case involving a lateral expansion. The retainer 100 can be fitted in a proper position and can maintain an adequate resilience even if external forces are applied thereto repeatedly by wearing and removing. The retainer 100 can also be repaired and corrected easily.

The function of the retainer 100 can be maintained sufficiently even if a contact region between the palate and the resin plate 102 is reduced and the retainer 100 is reduced in thickness.

Since the resin plate 102 is formed in a shape of a thin and narrow strip extending along the palate periphery, and an amount of resin is reduced significantly, intra-oral maxilla is hardly covered by the resin plate 102. Therefore, a good result of use can be expected with reduced odd feeling in wearing and a prolonged use, pronunciation difficulty or swallowing difficulty hardly occurs after wearing, and a wearer can sense temperature of foods and drinks sensitively. Further, by touching the periphery of the resin plate 102 with a tongue, consciousness about elevation of a tongue position can be improved.

A status of use by a patient can be recognized according to an impression in the resin plate 102 portion produced due to backup of the resin bar.

Since the wires are covered by resin and do no directly touch the palate, tongue, foods, or the like, it is not necessary to use wires made of expensive metals such as a titanium alloy, a cobalt chromium alloy, or a PGA (platinum alloy), and inexpensive standard products can be used. Further, with reduction of an amount of use of the synthetic resin, polishing work of the synthetic resin decreases in a manufacturing process, which makes it possible to reduce manufacturing time.

Reduction in the quantity of use of the resin and adoption of inexpensive wires can lead to a significant cost reduction. By minimizing exposure of metal portions, an aesthetically excellent retainer can be provided.

Odd feeling in wearing the retainer is small, and an adverse effect such as pronunciation difficulty can be fully prevented, whereby long-lasting retention of teeth is realized, and effective orthodontic treatment is achieved.

When fitted to the teeth, only a part of the C clasps 103 hooked to the molars at the rear of the mouth are exposed on the surface of the dentition in the maxillary retainer 100, and the portion is hardly seen from the outside even if the patient opens the mouth, which adds to the aesthetical excellence.

Moreover, the wires such as the reinforcing wire 104 and the clasps such as the C clasps 103 are brazed to each other and integrated. However, since brazed portions are embedded in the resin plate 102, the tip of the tongue does not touch the brazed portions, it is possible to prevent the tip of the tongue from being hurt and prevent a patient from feeling unpleasant.

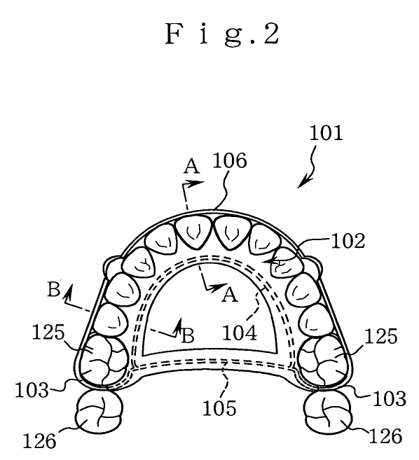

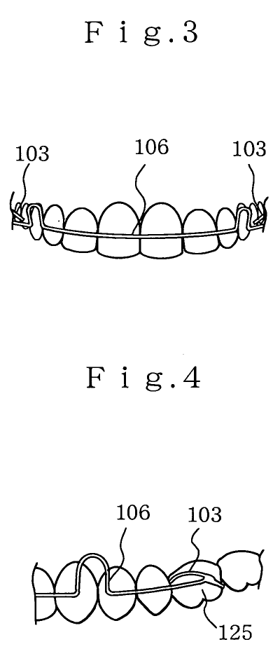

FIG. 2 shows another embodiment of the maxillary retainer. This maxillary retainer 101 includes the resin plate 102 formed in a frame shape, the U-shaped reinforcing wire 104 embedded in the resin plate 102, the C clasps 103 surrounding the first molars 125, the bridge wire 105 suspended between the C clasps 103, and the like. The wire 106, which is extended along near cervical area of lingual surface is brazed between the C clasps 103 as shown in FIGS. 3 and 4.

The resin plate 102 is provided along a side edge of a palate and has unevenness fitting with inside surfaces of teeth. The reinforcing wire 104 is extended from the C clasps 103 along the inside surface of the teeth, and the bridge wire 105 traversing a rear edge of the palate is suspended and brazed between the C clasps 103.

Note that, in this embodiment, the second molars 126 (or first molars) may be surrounded by the C clasps 103.

According to such a retainer 10l, in addition to the effects of the retainer 100, the retaining force can be increased by the labial wire 106.

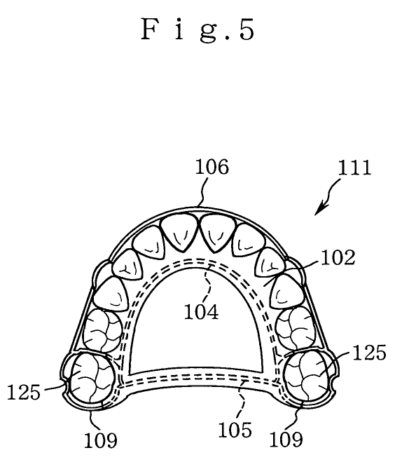

A retainer 111 shown in FIG. 5 has a form in which Adams clasps 109 are used around the first molars 125. In this way, Adams clasps may be used instead of the C clasps 103.

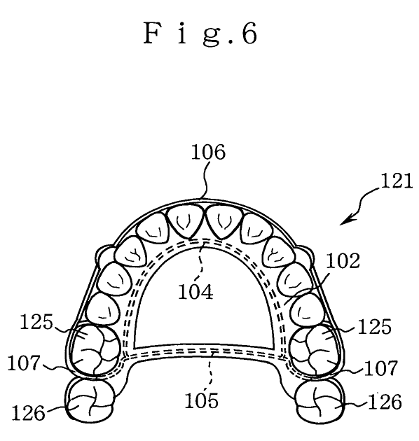

In a retainer 121 shown in FIG. 6, the first molars 125 and the second molars 126 (or first molars) are surrounded by bifurcated C clasps 107. This makes it possible to induce articulation of teeth and tusks in an eruptive phase.

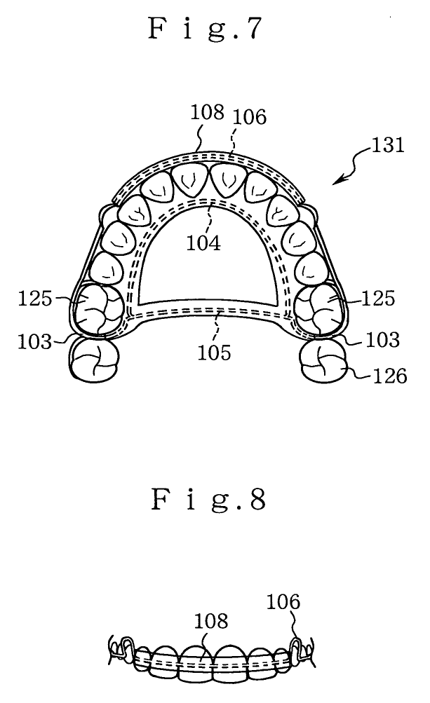

A retainer 131 shown in FIG. 7 has a form in which resin 108 is added to the labial wire 106 in the anterior teeth as shown in FIG. 8 in the retainer 101 shown in FIG. 2. The retainer 131 makes over-treatment for the respective teeth and tusks possible and is effective aesthetically.

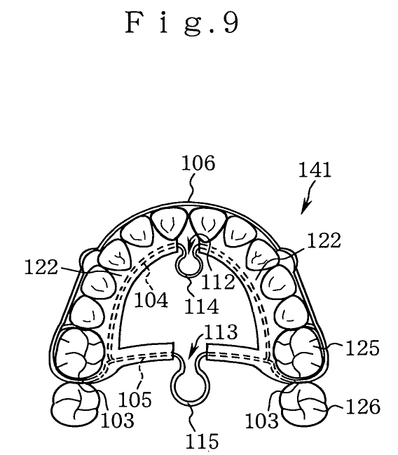

A retainer 141 shown in FIG. 9 has a form in which incisions 112 and 113 are provided in a median portion of the resin plate 102 traversing the anterior teeth and the palate, and omega loops 114 and 115 are added to the exposed reinforcing wire 102 and the bridge wire 105. According to the retainer 141, in accordance with growth of a patient, lateral expansion and compression are possible, and postoperative expansion and compression are also possible.

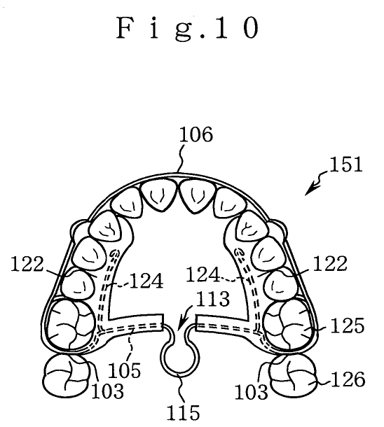

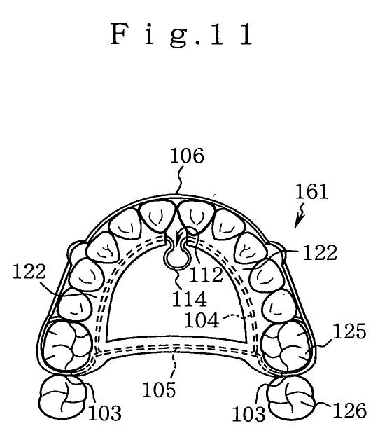

A retainer 151 shown in FIG. 10 has a form in which the reinforcing wire 104 and resin plate 102 in the anterior teeth region in the retainer 141 in FIG. 9 are cut, a resin plate 122 is extended only to canine teeth, and a reinforcing wire 124 is embedded in the resin plate 122. Even in such a case, lateral expansion and compression of the resin plate 122 embedded in the reinforcing wire 124 are possible, and postoperative expansion and compression thereof are also possible.

A retainer 161 shown in FIG. 11 has a form in which an incision 112 is provided in the median portion of the resin plate 102 in the anterior teeth in the retainer 101 in FIG. 2, the omega loop 114 is added to the reinforcing wire 104 as a spot. This is a form for intensifying consciousness about a tongue position with the spot.

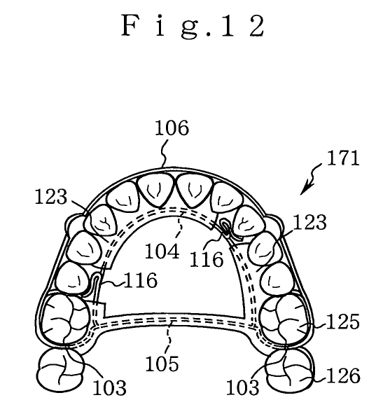

A retainer 171 shown in FIG. 12 has a form in which auxiliary spring wires 116 are brazed to the reinforcing wire 104 extended along near a palate side gingival portion after cutting a resin plate 123. It is possible to induce articulation of respective teeth and tusks.

Next, mandibular retainers will be explained.

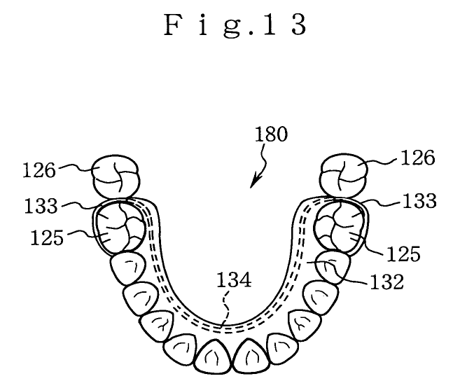

A mandibular retainer 180 in FIG. 13 has a U-shaped resin plate 132 with a portion thereof 4 to 5 mm from a contour periphery left formed of unevenness fitting with inside surfaces of teeth. A reinforcing wire 134 is embedded in the resin plate 132 along the inside surfaces of the teeth left, and a C clasp 133 is brazed to each end of the reinforcing wire 134.

As the reinforcing wire 134 and the bridge wire 105, a 0.9 mm wire is mainly used, and a 1.0 mm wire of larger diameter may be used depending upon a symptom of a patient.

The mandibular retainer 180 is attached with the C clasps 133 hooked to the first molars 125. Note that teeth to which the C clasps 133 are hooked are not limited to the first molars 125 such as second molars 126.

The mandibular retainer 180 has the same effects as the retainer 100 except an effect by the bridge wire 105. As shown in the figure, only a part of the C clasps 133 hooked to the molars at the rear of the mouth are exposed on the surface of the dentition in the maxillary retainer 100, and the portion is hardly seen from the outside even if the patient opens the mouth, which adds the aesthetical excellence.

Note that, in the orthodontic retainer of the present invention, the wires such as the reinforcing wire 134 and the clasps such as the C clasps 133 are brazed to each other and integrated. However, since brazed portions are embedded in the resin plate 132, the tip of the tongue does not touch the brazed portions, it is possible to prevent the tip of the tongue from being hurt and prevent a patient from feeling unpleasant.

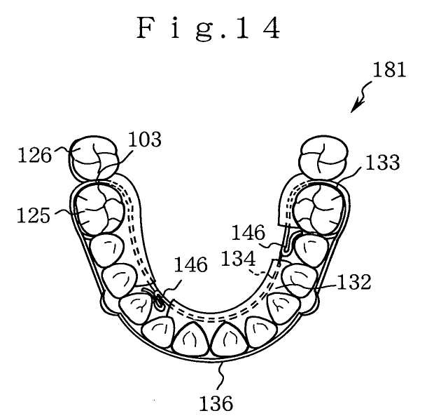

A retainer 181 shown in FIG. 14 is a mandibular retainer, which has a form in which auxiliary spring wires 146 are brazed to the reinforcing wire 134 after cutting a lingual resin plate 132. The retainer 181 is substantially the same as the retainer 171 in FIG. 12 except that the C clasps 133 are brazed to both ends of the wire 134, and the lingual resin plate 132 does not include a bridge wire. According to the retainer 181, it is possible to induce articulation of respective teeth and tusks.

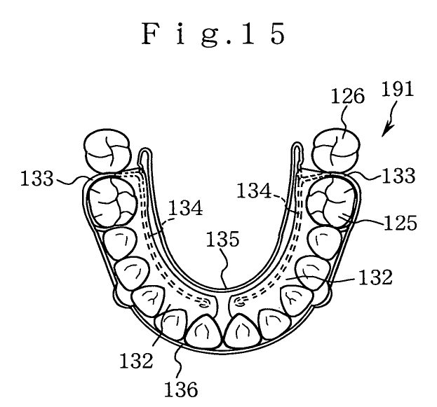

A retainer 191 shown in FIG. 15 has a shape in which the lingual resin plate 132 embedded with the reinforcing wire 134 is divided in a center thereof, wires 136 are brazed between the C clasps 133 and provided on the outside of the lingual resin plate 132, and an enlarged wire 135 is formed along the inside thereof. The lingual resin plate 132 has unevenness fitting with the inside surfaces of the teeth and is embedded with the reinforcing wire 134 continued in a U shape and extended from the C clasps 133. According to the retainer 191, in accordance with growth of a patient, lateral expansion and compression are possible, and postoperative expansion and compression are also possible. A structure of the retainer 191 shown in FIG. 15 may be used for a maxillary retainer.

Note that, in this embodiment, the first molars 125 are surrounded by the C clasps 133. However, the second molars 126 may be surrounded by the C clasps 133.

Since the reinforcing wire 134 and the like are embedded in the lingual resin plate 123, the wires may be brazed in any portions. In addition, although a 0.9 mm line is used as the main line, and a 0.7 mm line is used as the auxiliary line, a 1.0 mm line may be used as the main line as required as long as the line is a long-span line.

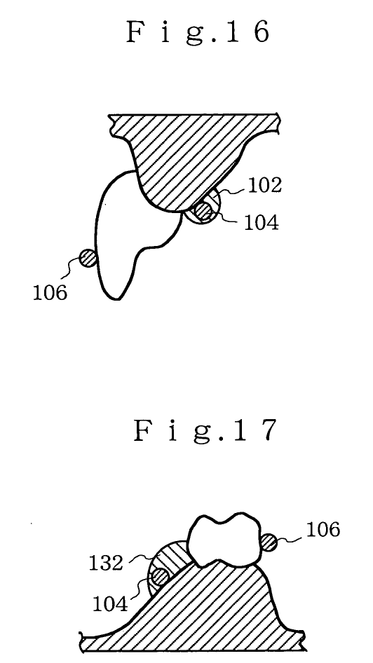

FIG. 16 is a diagram showing a correlation in the anterior teeth of the resin plate 102 and the reinforcing wire 104 on an A-A line section of the maxillary retainer 101 in FIG. 2. FIG. 17 is a diagram showing a correlation in the posterior teeth of the reinforcing wire 134 on a B-B line section of the maxillary retainer 101 in FIG. 2 and shows a degree of reduction in an amount of use of synthetic resin according to reasonable mutual complement.

Another embodiment of the present invention will be explained with reference to the drawings.

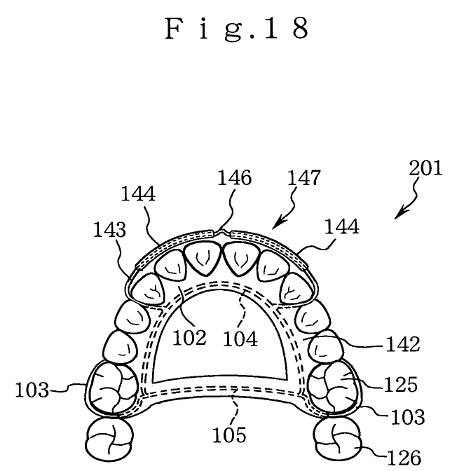

FIG. 18 shows another embodiment of the maxillary retainer. This retainer 201 has a form in which the first molars 125 are surrounded by the C clasps 103. The retainer 201 has a resin plate 142, which is the same as that in the retainer 100 in FIG. 1, and the shock absorber 147 is located in the anterior teeth. Note that the second molars 126 may be surrounded by the C clasps 103.

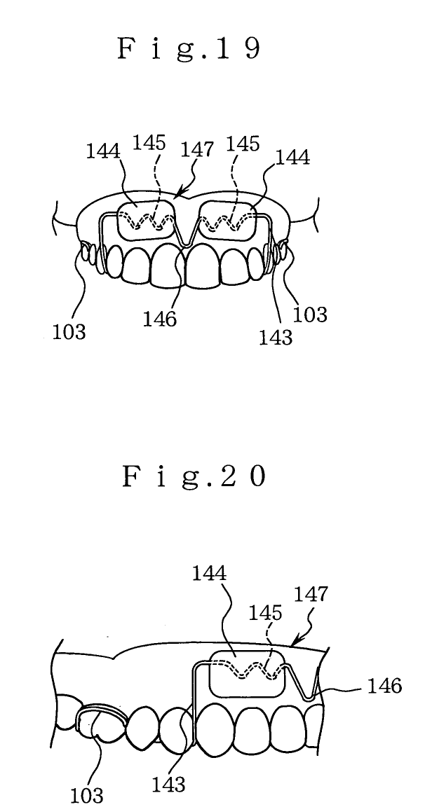

As shown in FIGS. 19 and 20, in the shock absorber 147, resin pads 144, in which a part of a retaining wire 143 is embedded, are arranged in two symmetrical portions in a part of a gingival region outside surface of the anterior teeth. The retaining wire 143 is brazed to the reinforcing wire 104 at both ends thereof and forms a loop frame so as to surround a part of the reinforcing wire 104 and the left and right anterior teeth (six teeth consisting of central incisors, lateral incisors, and canine teeth).

More specifically, both the ends of the retaining wire 143 is brazed to the reinforcing wire 104 in opposed positions near gaps between the canine teeth and first premolars, respectively, symmetrically in the inside portion of the dentition. The retaining wire 143 traverses the dentition through the gaps, reaches the outside of the dentition, rises to substantially a center height of the gingival region from that position, is bent in a horizontal direction by substantially 90° and bend in a wave-shape along the outside peripheral surface of the gingival region to form wave-shape portions 145 while forming a fixed gap with the outside surface of the gingival region, and arranged substantially symmetrically in the anterior teeth.

The resin pads 144, which are arranged symmetrically in the two portions extending the central incisors, the lateral incisors, and the canine teeth, keep the positions with the wave-shaped portions 145 on the gingival region outside peripheral surface of the retaining wire 143 embedded therein while forming a fixed gap with the gingival region outside surface through backup of the retaining wire 143.

In addition, in a medial portion between both the resin pads 144, the retaining wire 143 is exposed, and a recessed portion 146 bent in a recessed shape is formed to make it possible to take out the retainer 201 by hooking a finger to that portion.

With such a structure of the lip pad 147, since the fixed gap is formed between the resin pads 144 and the gingival region outside surface, even in a state in which pressure is caused by the perioral muscle, in particular, an orbicular muscle of mouth, the pressure is transmitted from the resin pads 144 to the retaining wire 143, the reinforcing wire 104, and finally to the retainer 201 by a spring-like effect. Then, the pressure is distributed to the entire system by complementary elastic deformation of the entire retainer 201, and the pressure is never directly given to the dental arch constituting the anterior teeth.

In addition, most of this lip pad 147 is at a position of the height of the gingival region, and most of the retaining wire 143 is embedded in the range pads 144. Thus, the retainer is not conspicuous even if a patient opens the mouth and is aesthetically excellent.

The retaining wire 143 portion is formed as the wave-shaped portion 145 bent in a wave shape, reinforcement and backup effects for the range pads 144 by the retaining wire 143 are demonstrated more, and the shock absorber effectively eases pressure caused by the perioral muscle such as the orbicular muscle of the mouth and the buccinator muscle.

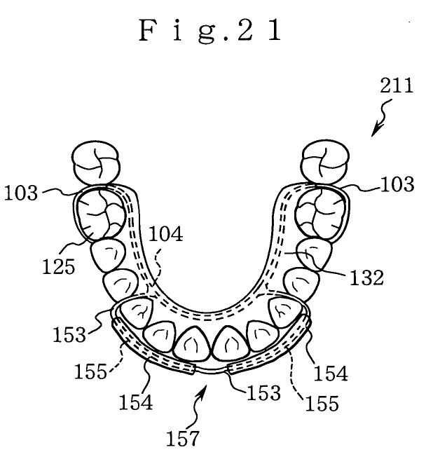

FIG. 21 shows an embodiment of the mandibular retainer according to the present invention. This retainer 211 has a basic form in which the first molars 125 are surrounded by the C clasps 103 and the lip pad 157 is located in the anterior teeth as in the maxillary retainer 201.

A palatal periphery resin plate 132, which has unevenness fitting with inside surfaces of teeth, continues in a U shape. The reinforcing wire 104 extended from the C clasps 103 are embedded in the resin plate 132. Note that, in this embodiment, the second molars 126 may be surrounded by the C clasps 103.

In addition, as in the maxillary retainer, in the lip pad 157, the retaining wire 153 is brazed to the reinforcing wire 104 at both the ends thereof and forms a loop frame so as to surround a part of the reinforcing wire 104 and the left and right anterior teeth (six teeth consisting of central incisors, lateral incisors, and canine teeth). Resin pads 154 embedded with a wave-shaped portion 155 (same as the wave-shaped portion 145 in FIG. 19) of the retaining wire 153 are arranged in two portions in symmetrical positions in portions of the gingival region outside surface of the anterior teeth. Consequently, pressure is not directly given to the dental arch constituting the anterior teeth.

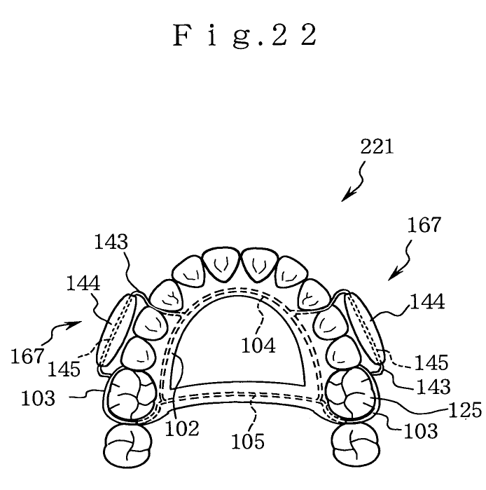

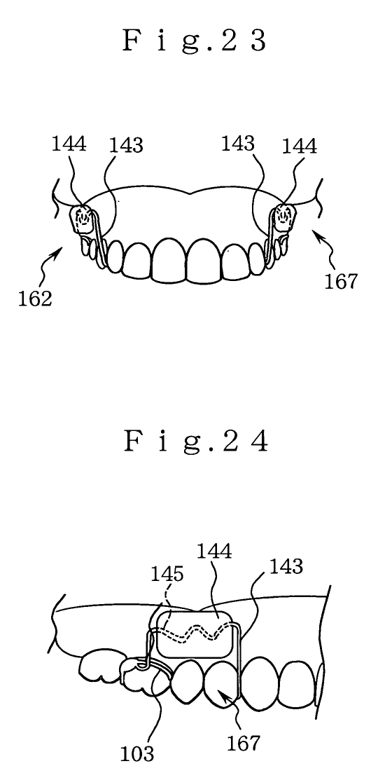

FIGS. 22 to 24 show another embodiment of the maxillary retainer. A structure of a retainer 221 is substantially the same as the retainer 201 and is provided with the buccal shield 167. The buccal shield 167 is constituted by the resin pads 144, which are embedded with the wave-shaped portion 145 of the retaining wire 143, symmetrically arranged in two portions in the portion of the gingival region outside surface of the posterior teeth. The retaining wire 143 is brazed at one end thereof to the reinforcing wire 104 at one end thereof through gaps between the canine teeth and the first premolars and brazed to at the other end thereof to portions located on the outside surfaces of the first molars of the C clasps 103 surrounding the first molars. The retaining wire 143 forms a loop frame so as to surround a part of the reinforcing wire 104 and the posterior teeth (the first premolars, the second premolars, and the first molars).

In addition, the resin pads 144 keeps the position with the retaining wire 143 while being opposed to the gingival region outside surface to form a fixed gap over the first premolars, the second premolars, and the first molars.

With such a structure of the buccal shield 167, the fixed gap is formed between the resin pads 144 and the outside surface of the gingival region. Even in a state in which pressure is caused by perioral muscle, in particular, the buccinator muscle, the pressure is transmitted from the resin pads 144 to the retaining wire 143, the reinforcing wire 104, and finally to the retainer 221 by a spring-like effect. Then, the pressure is distributed to the entire system by complementary elastic deformation of the entire retainer 221, and the pressure is never directly given to the dentition constituting the posterior teeth, and deformation of the dental arch of the posterior teeth can be prevented.

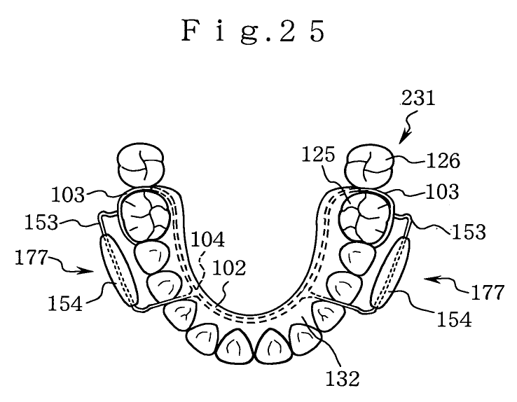

FIG. 25 shows an embodiment of the mandibular retainer. A structure of a retainer 231 is the same as the retainer 211, and a structure of the buccal shield 177 is the same as the buccal shield 167 of the retainer 221.

Note that, since the wires used in the present invention are actually embedded in a resin plate, the wires may be brazed in any portion. In addition, although a 0.9 mm wire is used, wires of other diameters may be used as required.

In addition, thickness of the resin pads 144 and 154 used in the lip pad 147,157, and the buccal shield 167,177 preferably have thickness of 2 to 3 mm, and a gap formed between the gingival region and the outside surface is preferably about 1 mm.

In the above-mentioned embodiment, the C clasps 103 are used as a fastener for fixing the retainers 201, 211, and the like. However, in the present invention, fasteners such as an Adams clasps and a bifurcated C clasps can be used depending upon an object of the present invention. For example, if the first molars and the second molars are surrounded by the bifurcated C clasps, it is possible to denture guidance of teeth in an eruptive phase.

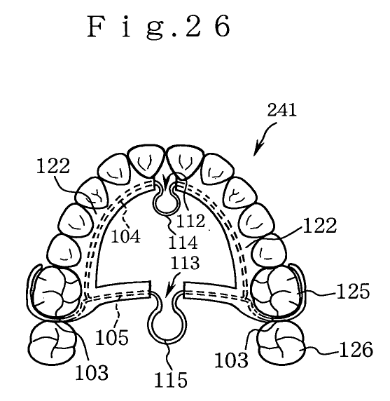

In addition, the maxillary retainer 201 and the mandibular retainer 211 of the present invention have many variations, which will be hereinafter introduced with reference to FIGS. 26 to 32. (In all the figures, the lip pad 147, 157, and the buccal shield 167,177 are not shown.)

FIGS. 26 to 29 show variations of the maxillary retainer.

A retainer 241 in FIG. 26 has a form in which the median portion of the resin plate 102 traversing the front teeth and the palate of the retainer 201 shown in FIG. 18 is cut to provide the incisions 112 and 113, and the omega loops 114 and 115 are added to the exposed reinforcing wire 104 and bridge wire 105. In this retainer 241, in accordance with growth of a patient, lateral expansion and compression are possible, and postoperative expansion and compression are also possible.

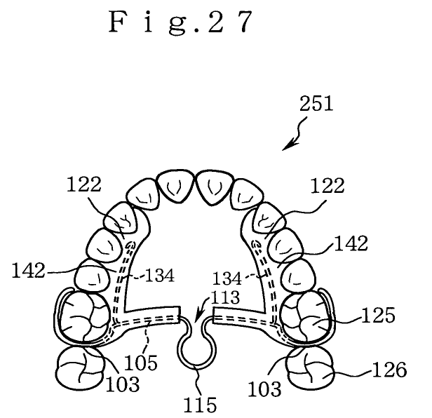

A retainer 251 in FIG. 27 has a form in which the reinforcing wire 104 of the anterior teeth and the resin plate 122 in FIG. 26 are cut, and the reinforcing wire 134 is embedded in the resin plate 142. In this retainer 251, in accordance with growth of a patient, lateral expansion and compression are possible, and postoperative expansion and compression are also possible.

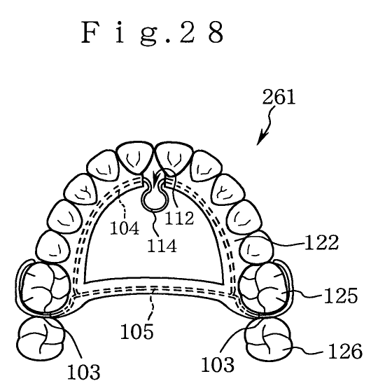

A retainer 261 in FIG. 28 has a form in which the incision 112 is provided in the median portion of the resin plate 102 of the anterior teeth of the retainer 241 in FIG. 26, and the omega loop 114 is added to the exposed reinforcing wire 104 as a spot. Consciousness about a tongue position with the spot can be intensified.

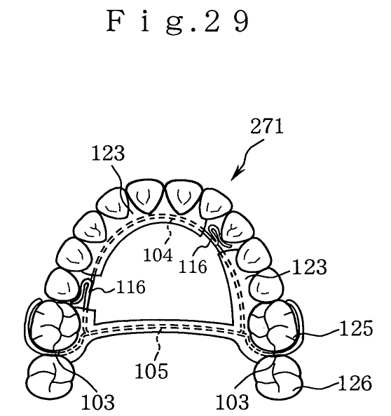

A retainer 271 in FIG. 29 has a form in which the resin plate 102 of the anterior teeth of the retainer 241 in FIG. 26 is cut, and the auxiliary spring wire 116 is brazed to the reinforcing wire 104, which is extended along near the cervix of palatal surface, in the incision of the resin 123. It is possible to effect denture guidance of respective teeth with the auxiliary spring wire 116.

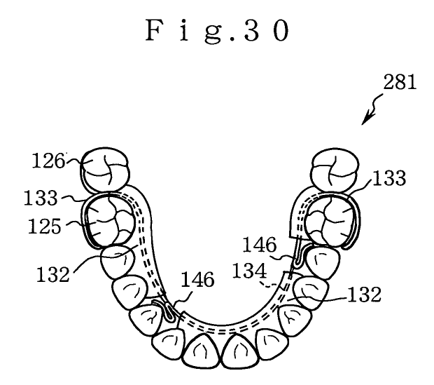

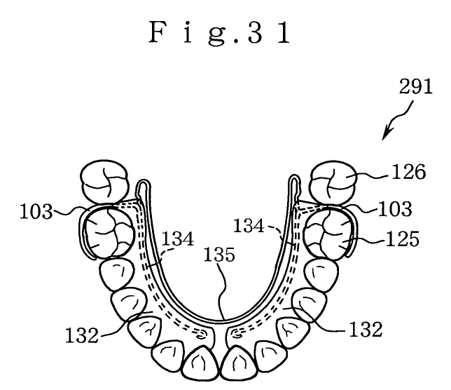

FIGS. 30 and 31 show variations of the mandibular retainer.

A retainer 281 in FIG. 30 has a form in which the lingual resin plate 132 in the anterior teeth of the retainer 180 in FIG. 13 is cut, and the auxiliary spring wire 146 is brazed to the auxiliary wire 134 in the incision of the resin plate 132. It is possible to denture guidance with the auxiliary spring wire 146.

A retainer 291 in FIG. 31 has a form in which the lingual resin plate 132 in the anterior teeth of the retainer 180 in FIG. 13 is divided in the center, and the enlarged wire 135 is extended in the lower portion of the resin plate 132. In this retainer 291, in accordance with growth of a patient, lateral expansion and compress are possible, and postoperative expansion and compression are also possible.

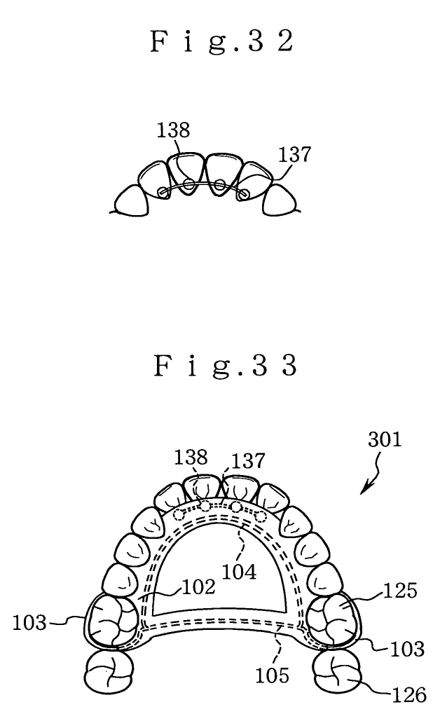

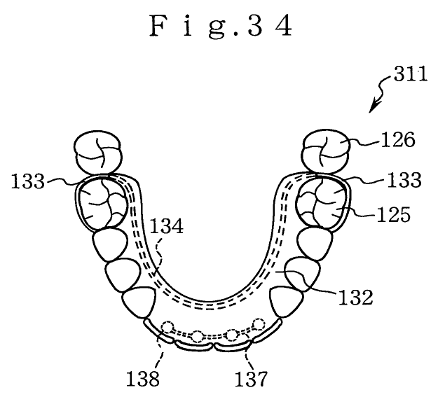

FIG. 33 shows a maxillary retainer 301 having a function for straightening the anterior teeth. FIG. 34 shows a mandibular retainer 311 similar to the maxillary retainer 301. In both the retainers, as shown in FIG. 32, four teeth, namely, left and right central incisors and lateral incisors are coupled by a coupling wire 137, which are directed bonded on the inside surfaces of the teeth by an adhesive portion 138, and coupling portions are covered by resin of the resin plate 102 and 132 when the retainer is attached. Other portions of the structure are the same as those in the retainers 100 and 180. Consequently, the four anterior teeth can be integrated by bonding of the coupling wire 137 to retain a state of the dentition properly while giving a straightening effect. In addition, the wire 137 is not conspicuous because it is embedded in the resin plate 102 and 132. The wire 137 is hardly seen from the outside because it is bonded on the inside surfaces of the dentition. Only a part of the C clasps 103 and 133 hooked to the molars at the rear of the mouth are exposed on the surface of the dentition when the retainer is attached, and the portion is hardly seen from the outside even if the patient opens the mouth, which adds the aesthetical excellence.

The maxillary retainer 301 and the mandibular retainer 311 are attached on teeth with the C clasps 103 and 133 hooked to the first molars 125. Note that teeth, to which the C clasps 103 and 133 are hooked, are not limited to the first molars 125 such as the second molars 126.

In the dental retainer of the present invention, the wires such as the reinforcing wires 104 and 134 and the clasps such as the C clasps 103 and 133 are brazed to each other and integrated. However, since brazed portions are embedded in the resin plate 102 and 132, the tip of the tongue does not touch the brazed portions, it is possible to prevent the tip of the tongue from being hurt and prevent a patient from feeling unpleasant.

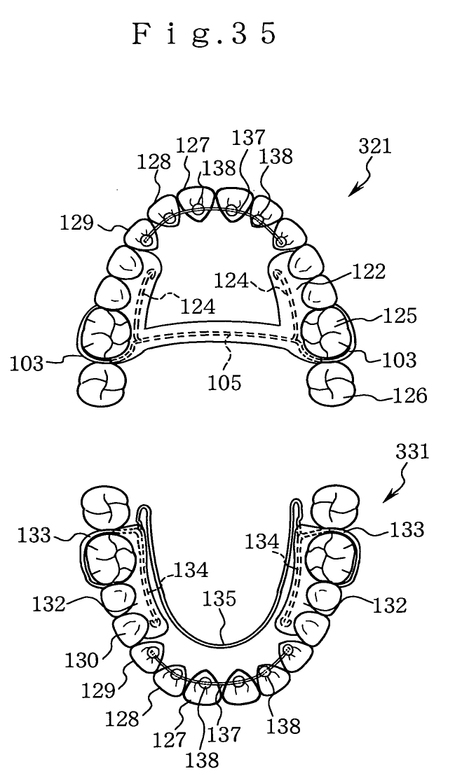

FIG. 35 shows a maxillary retainer 321 and a mandibular retainer 331 that are an embodiment of the present invention. In this embodiment, the wire 137, which is directly bonded on the inside surface of the anterior teeth, is also used, and the resin plate 102 and 132 and the reinforcing wires 104 and 134 on the inside surfaces of the anterior teeth which the wire 137 is bonded are not provided. With such a form, since a mounting object covering the gingival region of the anterior teeth is removed while a fixed state of the anterior teeth is maintained by the wire 137, a patient can easily have a meal.

Moreover, in the mandibular retainer 331, the U-shaped enlarged wire 135, which is brazed to both rear ends of the reinforcing wire 134 and extends to the inside surface of the anterior teeth along the inside of the resin plate 132, is also used. The enlarged wire 135 of an appropriate size is used according to a symptom of a patient, which makes it easy to an amount of lateral enlargement and reduction and makes it possible to cope with a patient in a growth phase.

Note that, in the embodiment shown in the figure, the wire 137 is bonded or the resin plate 102 and 132 and the reinforcing wires 104 and 134 are not provided in a range of the left and right central incisors 127, the lateral incisors 128, and the canine teeth 129. However, the range is not limited to this but can be decided appropriately according to a symptom of a patient.

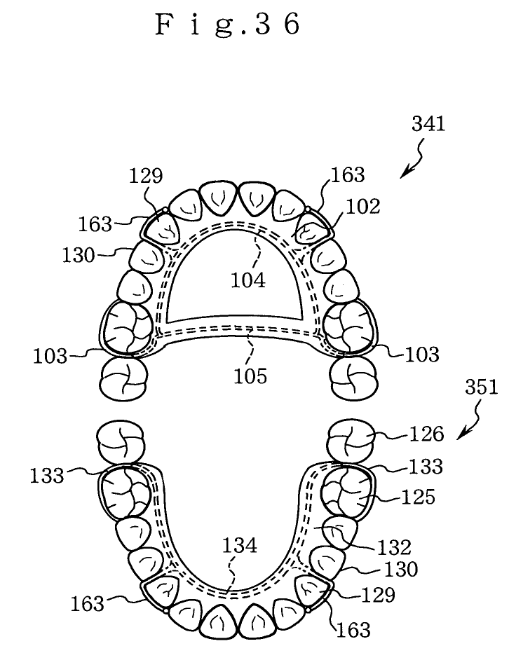

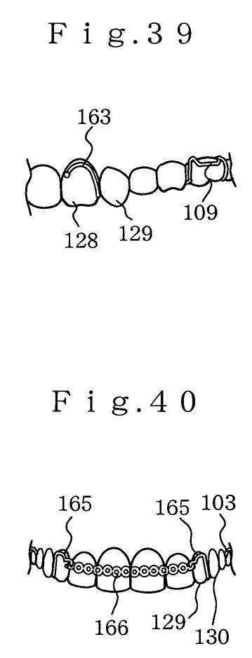

FIG. 36 shows retainers 341 and 351 that are an embodiment of the present invention. In this embodiment, a pair of boll clasps 163, which nip both side ends of the anterior teeth of a maxilla and a mandible are added to the retainers 100 and 180 in FIGS. 1 and 13 as shown in FIG. 39. This form makes it possible to adjust the dentition without hindering growth of the dentition and cope with a period of the mixed dentition.

Note that, in the embodiment shown in the figure, the ball clasps 163 are brazed to the reinforcing wires 104 and 134 in positions astride boundaries of the canine teeth 129 and the first premolars 130 to nip the six teeth between the left and right canine teeth 129. However, positions for brazing the ball clasps 163 are not limited to these positions but may be decided appropriately according to a symptom of a patient.

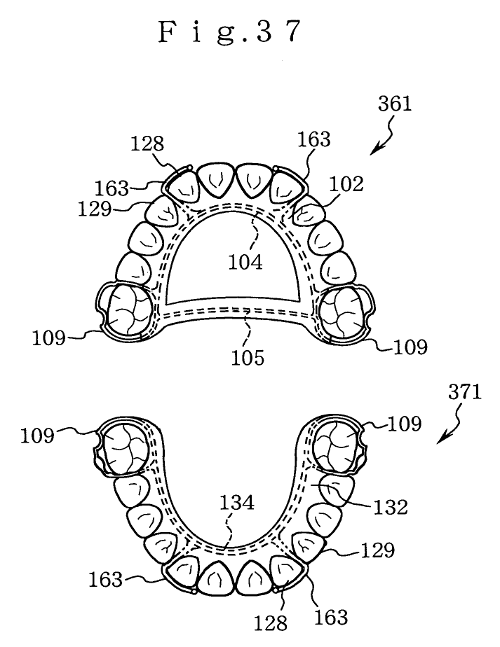

FIG. 37 shows retainers 361 and 371 that are an embodiment of the present invention. In this embodiment, a member hooked to the first molars 125 is changed from the C clasps 103 to the Adams clasps 109. This form makes it possible to adjust the dentition without hindering growth of teeth and the dentition before an eruptive phase and cope with the mixed dentition.

Note that in the embodiment shown in the figure, the ball clasps 163 are brazed to the reinforcing wires 104 and 134 in positions astride boundaries of the lateral incisors 128 and the canine teeth 129 to nip the four teeth between the left and right lateral incisors 128. However, positions for brazing the ball clasps 163 are not limited to these positions but may be decided appropriately according to a symptom of a patient.

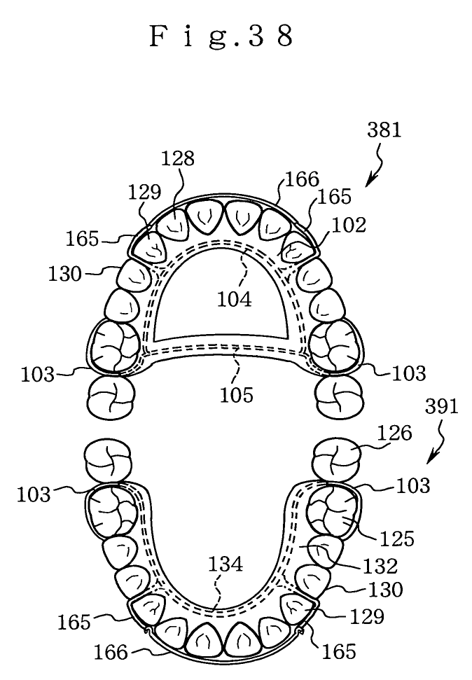

FIG. 38 shows retainers 381 and 391 that are an embodiment of the present invention. In this embodiment, the ball clasps 163 in the retainers 341 and 351 shown in FIG. 36 are replaced with hook clasps 165 as shown in FIG. 40, the respective hook clasps 165 are joined, and chains 166 of synthetic resin in abutment against the surface of the anterior portion are added.

With such a form, movement of the anterior teeth to the outside can be restrained to prevent projection and rotation of the anterior teeth. In addition, since the chains 166 consist of synthetic resin of the same color as the teeth, the retainer is not conspicuous when it is attached, and an aesthetic nature is not spoiled.

Note that, in the embodiment shown in the figure, the hook clasps 165 are brazed to the reinforcing wires 104 and 134 in positions astride boundaries of the canine teeth 129 and the first premolars 130 to bound the six teeth between the left and right canine teeth 129 with the chains 166. However, positions for brazing the hook clasps 163 are not limited to these positions but may be decided appropriately according to a symptom of a patient.

Another embodiment of the retainer will be explained with reference to the drawings.

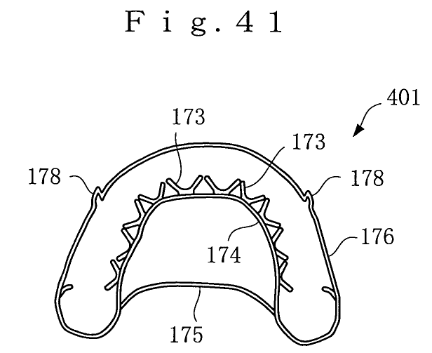

FIG. 41 shows a retainer 401.

The retainer 401 includes a wire 174 formed along the lingual surface of the dentition and a wire 176 formed along the labial surface of the dentition. The wire 174 and the wire 176 are coupled at left and right ends thereof so as to be folded back.

The lingual wire 174 is formed so as to extend along the cervical area on the lingual surface of the dentition, and a bridge wire 175 coupling the left and right of the lingual wire 174 is attached around second molars. Moreover, as shown in FIG. 44, metal wires 173 bent along the lingual sides of the cervix 184 of respective teeth 183 are brazed to the wire 174 so as to face the cervix 184.

The wire 176 is provided so as to pass substantially the center of the teeth along the labial surface of the dentition and includes U-shaped bent portions 178 located between canine teeth and first premolars.

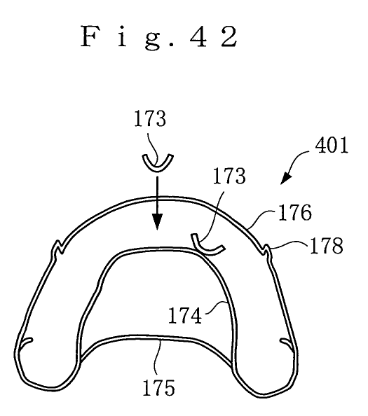

In the retainer 401, for example, as shown in FIG. 42, an outer peripheral portion formed of the wire 174, the wire 176, and the bridge wire 175 is formed first, and the metal wires 173 are bent to match the cervix 184 of the respective teeth 183 and then brazed to the wire 174 along a tooth profile. Note that it is also possible that wires cut in an appropriate length are bent in advance to form plural metal wires 173, and the metal wires 173 matching a required shape are picked up one after another out of the plural metal wires 173 to be brazed to the wire 174.

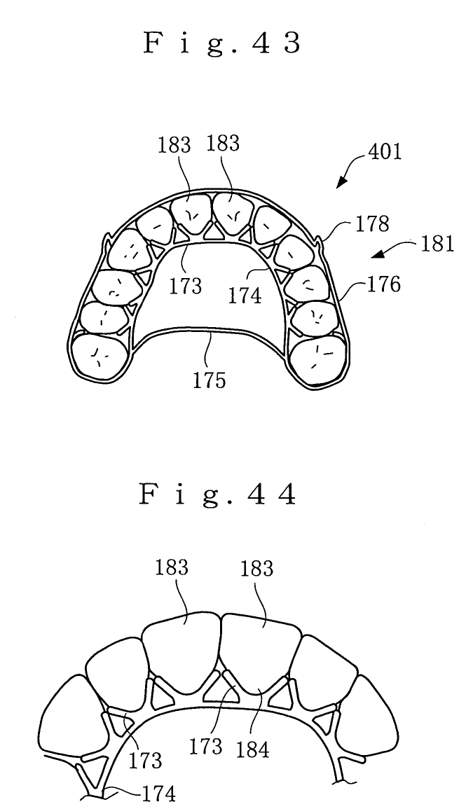

In the retainer 401, as shown in FIG. 43, teeth 183 are inserted and fixed between the lingual wire 174 and the labial wire 176. When the retainer 401 is attached on the teeth 183, since the metal wires 173 attached to the lingual wire 174 are fitted to the cervix 184 of the respective teeth 183 as shown in FIG. 44, the teeth 183 are retained surely.

Since the entire retainer 401 is made of metal and no resin is used, time and labor for molding resin are not required, the retainer 401 can be manufactured by brazing easily, and cost can be reduced. Since the retainer 401 does not include a resin portion, staining due to use does not occur. Since a palate portion and the like are not covered by resin, a wearer feels less change in the sense of taste and has less odd feeling, and can eat and drink while wearing the retainer. Since only metal wires are used, the retainer 401 can be easily cleaned and is excellent in cleanliness.

In addition, since the bridge wire 175 is brazed to the wire 174, strength of the wire 174 can be increased, and a retaining force for retaining the teeth 183 can be improved. Moreover, since the strength is increased, deformation of the retainer 401 can be prevented.

Next, another embodiment of the retainer will be explained.

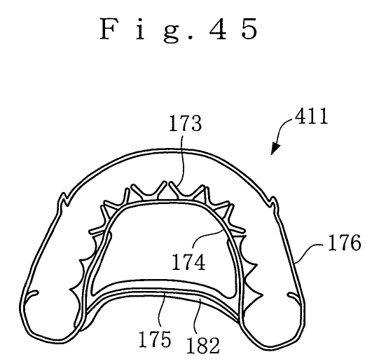

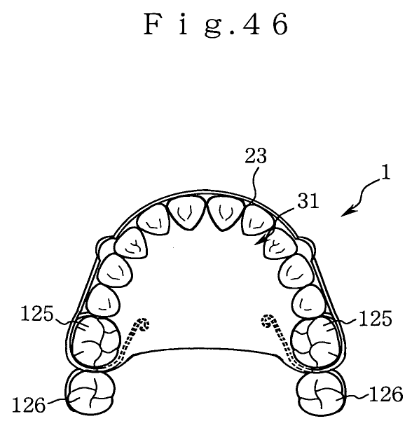

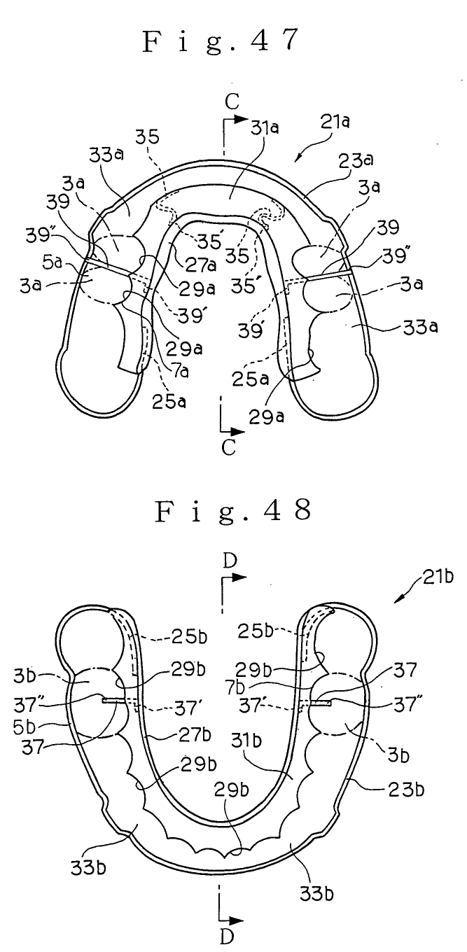

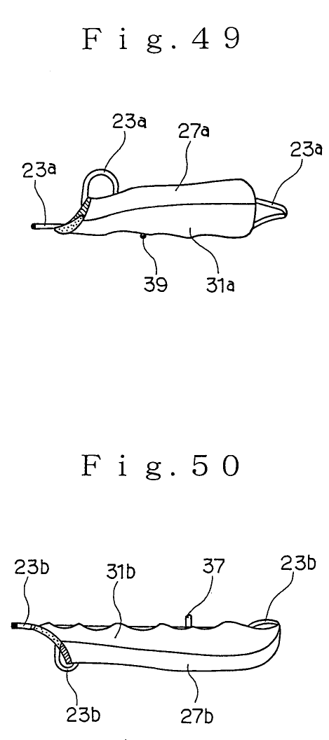

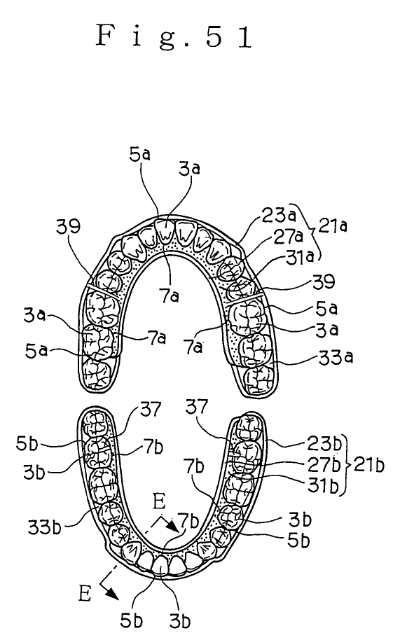

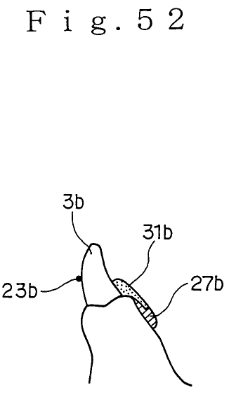

A retainer shown in FIG. 45 is constituted by heaping up a resin portion 182 on the wire 174 and the bridge wire 175 corresponding to posterior teeth as shown in the figure such that the resin portion 182 fits into the cervix 184 of molars. Consequently, a retaining force of the retainer 411 with improved fitting at the time of wearing can be improved. In addition, since the resin portion 182 fits into the posterior teeth, a wear has less odd feeling. Moreover, since resin fitting into the posterior teeth is provided, a retaining force can be improved. Since a palate portion is not covered by resin, satisfactory feeling of use can be kept. Note that the resin portion 182 may not be provided in the bridge wire 175.

1. A maxillary retainer comprising a resin plate retained to a palatal periphery that has clasps at both ends thereof, is embedded with a substantially U-shaped reinforcing wire extending along the inside of the dentition and a bridge wire coupling both the clasps and traversing a posterior edge of a palate thereof, includes unevenness fitting with inside surfaces of the teeth, and is formed in a shape with most portions thereof hollowed out leaving a part of 4 to 5 mm from a contour periphery thereof where the reinforcing wire and the bridge wire are embedded,
wherein the reinforcing wire extending from the clasps and the bridge wire are brazed to each other, and the periphery of the resin plate has a thickness minimized to a height of a cervix region at an anterior teeth region and piled the same as conventional retainer at posterior teeth.

2. A maxillary retainer according to claim 1,
wherein a labial arch wire in contact with the outside surfaces of the teeth is provided between both the clasps.

3. A maxillary retainer according to claim 2,
wherein resin is added to the labial arch wire at the anterior teeth.

4. A maxillary retainer according to claim 2,
wherein the resin plate is provided with an incision in a median portion of the resin plate traversing the anterior teeth and the palate, and an omega loop is added to the wires exposed from the incision.

5. A maxillary retainer according to claim 2,
wherein the reinforcing wire disposed adjacent and along the cervical area on the palate surface is added with an auxiliary spring wire after cutting the resin.

6. A maxillary retainer according to claim 2,
wherein the resin plate on the inside surface of the anterior teeth and the reinforcing wire embedded in the resin plate on the inside surface of the anterior teeth are not provided, and the resin plate is provided with an incision in a median portion at a posterior edge thereof traversing the palate and an omega loop is added to the wire portion exposed from the incision.

7. A maxillary retainer according to claim 1,
wherein the resin plate is provided with an incision in a median portion at an anterior teeth thereof and an omega loop is added to the wire portion exposed from the incision.

8. A maxillary retainer according to claim 1, further comprising a shock absorber including a retaining wire, which has opposed ends thereof joined to the reinforcing wire that includes the clasps and forms a loop frame surrounding a part of the reinforcing wire and a part of the dentition, and a resin pad in which a part of the retaining wire is embedded,
wherein the reinforcing wire, the bridge wire and the retaining wire are brazed to each other and the periphery of the resin plate on the dentition side having a thickness minimized to the height of the cervix at the anterior teeth and to the height of the crown bulge at the molar region, and
the resin pad of the lip pad is retained at a position opposed to the outside surface of the gingival region with a gap formed in the position in a state in which the retainer is fitted to the palate.

9. A maxillary retainer according to claim 8,
wherein the portion of the retaining wire embedded in the resin pad is formed as a wave-shaped portion bent in a wave shape.

10. A maxillary retainer according to claim 8,
wherein the resin plate is retained at a position opposed to the outside surface of the gingival region of the anterior teeth with a gap formed in the position.

11. A maxillary retainer according to claim 8,
wherein the resin plate is retained at a position opposed to the outside surface of the gingival region of the posterior teeth with a gap formed in the position.

12. A maxillary retainer according to claim 1, wherein the inside surfaces of the anterior teeth are directly bonded to a coupling wire, and unevenness fitting with inside surfaces of the teeth is provided.

13. A maxillary retainer according to claim 12,
wherein the resin plate and the reinforcing wire on the inside surface of the anterior teeth, where the coupling wire is bonded, are not provided.

14. A maxillary retainer according to claim 1,
wherein a pair of ball clasps, which are brazed to the reinforcing wire and nip both side ends of the anterior teeth, are added.

15. A maxillary retainer according to claim 14,
wherein the ball clasps are replaced with hook clasps and a synthetic resin chain, which joins the hook clasps and is in contact with the surfaces of the anterior teeth, are added.

16. A maxillary retainer according to claim 1, wherein the clasps are C clasps surrounding first molars.

17. A maxillary retainer according to claim 1, wherein the clasps are Adams clasps surrounding the first molars.

18. A maxillary retainer according to claim 1, wherein the clasps are bifurcated C clasps fitted around the first and second molars, respectively.

19. A mundibular retainer comprising a resin plate that has clasps at both ends thereof, includes a labial arch wire extending along outside surfaces of the dentition and unevenness fitting with inside surfaces of the teeth, and is hollowed out leaving a portion 4-5 mm from a contour periphery thereof where a substantially U-shaped reinforcing wire extending along the inside of the dentition is embedded,
wherein the reinforcing wire and the labial arch wire are brazed to each other, the periphery of the resin plate has a thickness thereof minimized to a height of a cervix region at an anterior teeth region and piled the same as conventional retainer at posterior teeth, and
resin on a lingual surface of anterior teeth is divided, and an enlarged wire is added along a lower portion of the resin plate.

20. A mundibular retainer comprising a resin plate that has clasps at both ends thereof, includes unevenness fitting with inside surfaces of the teeth, and is hollowed out leaving a portion 4-5 mm from a contour periphery thereof where a substantially U-shaped reinforcing wire extending along the inside of the dentition is embedded,
wherein the periphery of the resin plate has a thickness thereof minimized to a height of a cervix region at an anterior teeth region and piled the same as conventional retainer at posterior teeth, and
the resin plate is provided with an incision in a median portion at anterior teeth thereof such that an omega loop is added to the wires exposed from the incision.

21. A mandibular retainer comprising:
a resin plate that has clasps at both ends thereof, includes unevenness fitting with inside surfaces of the teeth, and is hollowed out leaving a portion 4-5 mm from a contour periphery thereof where a substantially U-shaped reinforcing wire extending along the inside of the dentition embedded;
a lip pad and a buccal shield including a retaining wire, which has opposed ends thereof joined to the reinforcing wire that includes the clasps and forms a loop frame surrounding a part of the reinforcing wire and a part of the dentition, and a resin pad in which a part of the retaining wire is embedded,
wherein the reinforcing wire and the retaining wire are brazed to each other and the periphery of the resin on the dentition side having a thickness minimized a the height of a crown bulge region at a prosterior teeth region in the same manner as the conventional retainer, and
the resin pad of the lip pad and the buccal shield is retained at a position opposed to the outside surface of the gingival region with a gap formed in the position in a state in which the retainer is fitted to the dentition.

22. A mandibular retainer according to claim 21,
wherein the portion of the retaining wire embedded in the resin pad is bent in a wave shape.

23. A mandibular retainer according to claim 21,
wherein the resin pad of the shock absorber is retained at a position opposed to the outside surface of the gingival region of the anterior teeth with a gap formed in the position.

24. A madibular retainer according to claim 21,
wherein the resin pad is retained at a position opposed to the outside surface of the gingival region of the posterior teeth with a gap formed in the position.

25. A mandibular retainer comprising a resin plate that has clasps at both ends thereof, includes unevenness fitting with inside surfaces of the teeth, and is hollowed out leaving a portion 4-5 mm from a contour periphery thereof where a substantially U-shaped reinforcing wire extending along the inside of the dentition is embedded,
wherein the periphery of the resin plate having its thickness minimized to the height of a cervix region at an anterior teeth region and piled resin the same as conventional retainer at posterior teeth, and the unevenness fitting with inside surfaces of the teeth is fitted with the inside surfaces of the anterior teeth to which a coupling wire is directly bonded.

26. A mandibular retainer according to claim 25,
wherein the resin plate and the reinforcing wire on the inside surface of the anterior teeth, where the coupling wire is bonded, are not provided.

27. A mandibular retainer according to claim 25,
wherein a pair of ball clasps, which are brazed to the reinforcing wire and nip both side ends of the anterior teeth, are added.

28. A mandibular retainer according to claim 27,
wherein the ball clasps are replaced with hook clasps and a synthetic resin chain, which joins the hook clasps and is in contact with the surfaces of the anterior teeth, are added.

29. A mandibular retainer according to claim 19,
wherein the clasps are C clasps surrounding first molars.

30. A mandibular retainer according to claim 19,
wherein the clasps are Adams clasps surrounding the first molars.

31. A mandibular retainer according to claims 19,
wherein the clasps are bifurcated C clasps fitted around the first and second molars, respectively.

32. A retainer that is fitted to an orthodontically treated dentition to retain the dentition such that the dentition does not relapse to a state before orthodontic treatment,
wherein a bent metal wire is jointed to a main wire, which is disposed along a cervix of the lingual surface of the dentition, to be fitted to the cervix of the respective teeth such that the teeth are retained.

33. A retainer according to claim 32,
wherein the retainer is provided with a molded resin portion at a region of a posterior tooth along a shape of a cervix of the posterior tooth.
